(19) United States
(12) Patent Application Publication
(10) Pub. No.: US 2013/0121164 A1
(43) Pub. Date: May 16, 2013

(54) One to Many OAM/Protection Inter-Working Function

(71) Applicants: Lior Shabtay, Ramat Gan (IL); Shuki Peles, Raanana (IL); Zhiping Jia, Beijing (CN)

(72) Inventors: Lior Shabtay, Ramat Gan (IL); Shuki Peles, Raanana (IL); Zhiping Jia, Beijing (CN)

(73) Assignee: Nokia Siemens Networks Ethernet Solutions, Ltd., Hod Hasharon (IL)

(21) Appl. No.: 13/294,343

(22) Filed: Nov. 11, 2011

(51) Int. Cl. H04L 12/26

(52) U.S. Cl. 370/241.1

(57) ABSTRACT

A novel and useful one-to-many OAM/protection inter-work function (IWF). The mechanism stitches a single OAM session (e.g., a CCM session) on a multi-traffic class (TC) M-domain to multiple OAM-sessions (which monitor different transport entities or connections) on a single-TC S-domain using duplication and filtering of OAM messages at the ENNI. Using the OAM sessions, protection decision manipulation is performed to coordinate the protection decisions of the different connections serving the different TCs of the same S-domain endpoint. The manipulation includes manipulating fields in one OAM-session as a function of information gained from an OAM-session monitoring a different transport entity such that the first connection is forced to follow protection decisions based on the second OAM-session. Bundled single-TC connections are forced to take protection decisions that steer user traffic through transport entities provisioned in advance to share the same fate in the event of link or equipment failures.

### TECHNICAL FIELD

The disclosure relates generally to carrier Ethernet transport (CET) networks and more particularly relates to a system and method for providing end to end OAM connectivity/protection inter-working function (IWF) in networks supporting multiple traffic class (TC) connections.

### BACKGROUND

The growth in demand for telecommunication services is increasing at an ever-quickening pace. The majority of the demand is being driven by the explosion in the use of the Internet and a steady stream of new applications being introduced which further increase the demand for increased bandwidth. With time, a smaller and smaller portion of Internet traffic is carried by circuit switched transport facilities. In the case of Metropolitan Area Networks (MANs), a significant part of the traffic is transported over SONET/SDH based networks most of which were originally resigned for voice traffic. With time, more and more customers are using the networks for transporting data rather than voice.

The requirements for networked communications within the user community have changed dramatically over the past two decades. Several notable trends in the user community include (1) the overwhelming domination of Ethernet as the core networking media around the world; (2) the steady shift towards data-oriented communications and applications; and (3) the rapid growth of mixed-media applications. Such applications include everything from integrated voice/data/video communications to the now commonplace exchanges of MP3 music files and also existing voice communications which have migrated heavily towards IP/packet-oriented transport.

Ethernet has become the de facto standard for data-oriented networking within the user community. This is true not only within the corporate market, but in many other market segments as well. In the corporate market, Ethernet has long dominated at all levels, especially with the advent of high-performance Ethernet switching. This includes workgroup, departmental, server and backbone/campus networks. Even though many of the Internet Service Providers (ISPs) in the market today still base their WAN-side communications on legacy circuit oriented connections (i.e. supporting Frame Relay, xDSL, ATM, SONET) in addition to Ethernet in a significant part of the newer installations, their back-office communications are almost exclusively Ethernet. In the residential market, most individual users are deploying 10 or 100 Mbps Ethernet within their homes to connect PCs to printers and to other PCs (in fact, most PCs today ship with internal Ethernet cards) even though the residential community still utilizes a wide range of circuit-oriented network access technologies.

The use of Ethernet, both optical and electrical based, is increasing in carrier networks due to advantages of Ethernet and particularly Optical Ethernet, namely its ability to scale from low speeds to very high rates and its commodity-oriented nature. With the rapid increase in the demand for user bandwidth, and the equally impressive increase in the performance of Ethernet with the LAN environment, the demand for Metropolitan network performance is rapidly increasing. In response, there has been a massive explosion in the amount of fiber being installed into both new and existing facilities. This is true for both the corporate and residential markets.

Virtual private LAN service (VPLS) is a way to provide Ethernet based multipoint to multipoint communication over Internet Protocol (IP)/Multiprotocol Label Switching (MPLS) networks. It allows geographically dispersed sites to share an Ethernet broadcast domain by connecting sites through pseudo-wires. Example technologies that can be used as pseudo-wire include Ethernet over MPLS, L2TPv3, etc. Two IETF standards that track RFCs describing VPLS establishment include RFC 4761 “Virtual Private LAN Service (VPLS) Using BGP for Auto-Discovery and Signaling” and RFC 4762 “Virtual Private LAN Service (VPLS) Using Label Distribution Protocol (LDP) Signaling”.

VPLS is a virtual private network (VPN) technology which allows any-to-any (multipoint) connectivity. In a VPLS, the local area network (LAN) at each site is extended to the edge of the provider network. The provider network then emulates a switch or bridge to connect all of the customer LANs to create a single bridged LAN.

A VPLS creates an emulated LAN segment for a given set of users. It provides a layer 2 broadcast domain that is capable of learning and forwarding using Ethernet MAC addresses for a given set of users.

Today, Ethernet is the predominant technology used for Local Area Network (LAN) connectivity and is gaining acceptance as an access technology as well. This is true especially in Metropolitan Area Networks (MANs) and Wide Area Networks (WANs). In a typical scenario, an Ethernet port connects a customer to the Provider Edge (PE) device. Customer traffic is subsequently mapped to a specific MPLS-based Layer 2 Virtual Private Network (VPN).

Traditional LANs provide unicast, broadcast and multicast services. Locations that belong to the same broadcast domain and that are connected via an MPLS network expect broadcast, multicast and unicast traffic to be forwarded to the proper locations. This requires MAC address learning on a per LSP basis, forwarding unicast destination traffic according to the learned information, packet replication across LSPs for multicast/broadcast traffic and for flooding of unknown unicast destination traffic.

A main goal of Virtual Private LAN Services (VPLS) is to provide connectivity between customer sites situated in the MAN or WAN as if they were connected via a LAN. To accomplish this, a major attribute of Ethernet must be provided, namely the flooding of broadcast traffic, multicast traffic, and traffic with unknown destination MAC addressed to all ports. To provide flooding within a VPLS, all unicast unknown address, broadcast and multicast frames are flooded over the corresponding “pseudo-wires” to all relevant provider edge nodes that participate in the VPLS. Note that multicast packets are a special case and are not necessarily flooded to all VPN members. A pseudo-wire is a made up of a pair of unidirectional virtual circuit Label Switched Paths (LSPs). Throughout this document, the terms pseudo-wire and transport-entity are used to denote a point-to-point logical link connecting different nodes in the network, regardless of the technology used for its implementation, e.g., MPLS, etc. Depending on the technology, the pseudo-wire may be an MPLS-VC, a point-to-point Virtual LAN (VLAN)-based trail, an ATM-VC, etc.

A provider edge node uses different techniques to associate packets received from the client with connections. Example techniques include port mapping and VLAN mapping in which the received packet is associated with a connection according to the provider edge device port from which it was received or according to the port from which it was received as well as the VLAN with which it is tagged, respectively. Packets mapped to a VPLS connection, are forwarded to one or more of the sites associated with that particular VPLS connection. In case of a VPLS connection, the forwarding is performed by bridging-capable nodes throughout the network that bridge between pseudo-wires dedicated to that VPLS. The pseudo-wires are point-to-point ‘sub-connections’ of that VPLS, functioning to connect the bridging-capable nodes. These bridging capable nodes must be able to first associate the received packet with a VPLS and then, within the context of the VPLS, associate a destination MAC address (or a destination MAC-address and VLAN-tag value) with a pseudo-wire comprised by that VPLS in order to forward a packet. It is not practical to require these provider nodes to statically configure an association of every possible destination MAC address with a pseudo-wire. Thus, a bridging mechanism is required to dynamically learn MAC addresses (or MAC-address and VLAN pairs) on both physical ports and virtual circuits and to forward and replicate packets across both physical ports and pseudo-wires to which they are associated.

Provider edge (PE) devices participating in a VPLS-based VPN must appear as an Ethernet bridge to connected customer edge (CE) devices. Received Ethernet frames must be treated in such a way as to ensure CEs can be simple Ethernet devices. When a PE receives a frame from a CE, it inspects the frame and learns the source MAC address, storing it locally along with LSP routing information. It then checks the frame's destination MAC address. If it is a broadcast or multicast frame, or the MAC address is not known to the PE, it floods the frame to all PEs in the mesh.

Bridging functionality operates on the original Layer 2 portion of the packet. The bridge functions to learn new source MAC addresses of ingress packets and to associate them with the outbound pseudo-wire it is to be sent out on.

### SUMMARY

There is thus provided in accordance with the invention, a method of providing end to end OAM connectivity in a carrier Ethernet network (CEN), said method comprising provisioning a first group of connections, provisioning an additional single connection, and mapping a plurality of administration and maintenance (OAM) sessions on said first group of connections to a single OAM session on said single connection.

There is also provided in accordance with the invention, a method of providing end to end protection in a carrier Ethernet network (CEN), said method comprising provisioning a first group of connections in an S-domain of said CEN, provisioning an additional connection in an M-domain of said CEN, mapping a plurality of operation, administration and maintenance (OAM) sessions on said group of connections to a single OAM session on said single connection, and manipulating protection decisions for said first group of connections such that active transport entities of said first group of connections mapped to said single connection all share the same fate.

There is further provided in accordance with the invention, a communications switch for use in a carrier Ethernet network, comprising a plurality of network ports for interfacing said switch to one or more communication links, a network processor comprising a multiple traffic class (TC) protection module operative to provide end to end protection in said carrier Ethernet network, said multiple TC protection module operative to mapping a plurality of operation, administration and maintenance (OAM) sessions on a first group of connections to a single OAM sessions on a single connection, manipulating protection decisions for said first group of connections such that all active paths in said first group of connections share the same fate.

### BRIEF DESCRIPTION OF THE DRAWINGS

The mechanism is herein described, by way of example only, with reference to the accompanying drawings, wherein:

FIG. 1 is a diagram illustrating an example carrier Ethernet network architecture incorporating an MPLS core;

FIG. 2 is a diagram illustrating an example VPLS network with VLAN spokes;

FIG. 3 is a diagram illustrating an example VPLS network with MPLS and VLAN spokes;

FIG. 4 is a diagram illustrating an example one-to-many OAM/protection IWF service;

FIG. 5 is a diagram illustrating a multiple TC E-LAN with endpoints on S-domain and M-domain subnets;

FIG. 6 is a diagram illustrating multiple VSI based multiple TC E-LAN with endpoints on

S-domain and M-domain subnets;

FIG. 7 is a flow diagram illustrating an example of the one-to-many OAM/protection IWF of the present invention; and

FIG. 8 is a functional block diagram illustrating an example switch incorporating the one-to-many OAM/protection IWF mechanism of the present invention.

### DETAILED DESCRIPTION

The mechanism will now be described more fully hereinafter with reference to the accompanying drawings, in which preferred embodiments of the mechanism are shown. The mechanism may, however, be embodied in many different forms and should not be construed as limited to the embodiments set forth herein. Rather, these embodiments are provided so that this disclosure will be thorough and complete, and will fully convey the scope of the mechanism to those skilled in the art. Like numbers refer to like elements throughout, and prime notation is used to indicate similar elements in alternative embodiments.

To aid in illustrating the principles of the mechanism, an example network is presented in connection with the one to many OAM/protection IWF mechanism. It is not intended, however, that the mechanism be limited to the configurations and embodiments described herein. It is appreciated that one skilled in the networking, electrical and/or software arts may apply the principles of the mechanism to numerous other types of networking devices and network configurations as well, including other types of synchronous data streams and asynchronous transport networks without departing from the scope of the mechanism.

Many aspects of the mechanism described herein may be constructed as software objects that execute in embedded devices as firmware, software objects that execute as part of a software application on either an embedded or non-embedded computer system running a real-time operating system such as Windows mobile, WinCE, Symbian, OSE, Embedded LINUX, etc., or non-real time operating systems such as Windows, UNIX, LINUX, etc., or as soft core realized HDL circuits embodied in an Application Specific Integrated Circuit (ASIC), Field Programmable Gate Array (FPGA), network processor or as functionally equivalent discrete hardware components.

Throughout this document, the terms packet and frame are used interchangeably and are intended to denote a protocol data unit (PDU) adapted to transport data and/or control information from one point to another. References are made to Ethernet frames, IP packets, etc. which are example protocol data units (PDUs) associated with various networks such as Ethernet, H.323, ISO OSI TCP/IP protocol stack. It is appreciated, however, that the mechanism may be adapted for use in other types of networks that transmit other types of PDUs as well. The principles of MAC based transmission as described herein are not limited to Ethernet MAC devices and can be applied to other types of Layer 2 protocols and devices as well.

The most popular types of VPLS-spokes are VLAN-spokes and MPLS-spokes. A VLAN spoke is a spoke site that resides in a non-MPLS, VLAN enabled network device (e.g., according to IEEE 802.1Q or 802.1ad). A MPLS spoke is a spoke site that resides in an MPLS enabled network device. Such a spoke is connected to one or two VPLS VSIs through MPLS transport entities (e.g., pseudo-wires).

Note that throughout this document, the term communications transceiver or device is defined as any apparatus or mechanism adapted to transmit, receive or transmit and receive information through a medium. The communications device or communications transceiver may be adapted to communicate over any suitable medium, including wireless or wired media.

The word ‘exemplary’ is used herein to mean ‘serving as an example, instance, or illustration.’ Any embodiment described herein as ‘exemplary’ is not necessarily to be construed as preferred or advantageous over other embodiments.

Some portions of the detailed descriptions which follow are presented in terms of procedures, logic blocks, processing, steps, and other symbolic representations of operations on data bits within a computer memory. These descriptions and representations are the means used by those skilled in the data processing arts to most effectively convey the substance of their work to others skilled in the art. A procedure, logic block, process, etc., is generally conceived to be a self-consistent sequence of steps or instructions leading to a desired result. The steps require physical manipulations of physical quantities. Usually, though not necessarily, these quantities take the form of electrical or magnetic signals capable of being stored, transferred, combined, compared and otherwise manipulated in a computer system. It has proven convenient at times, principally for reasons of common usage, to refer to these signals as bits, bytes, words, values, elements, symbols, characters, terms, numbers, or the like.

It should be born in mind that all of the above and similar terms are to be associated with the appropriate physical quantities they represent and are merely convenient labels applied to these quantities. Unless specifically stated otherwise as apparent from the following discussions, it is appreciated that throughout the mechanism, discussions utilizing terms such as ‘processing,’ ‘computing,''calculating,’ determining,“displaying' or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices or to a hardware (logic) implementation of such processes.

The flowchart and block diagrams in the Figures illustrate the architecture, functionality, and operation of possible implementations of systems, methods and computer program products according to various embodiments of the present mechanism. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Note that the mechanism can take the form of an entirely hardware embodiment, an entirely software embodiment or an embodiment containing a combination of hardware and software elements. In one embodiment, a portion of the mechanism can be implemented in software, which includes but is not limited to firmware, resident software, object code, assembly code, microcode, etc.

Furthermore, the mechanism can take the form of a computer program product accessible from a computer-usable or computer-readable medium providing program code for use by or in connection with a computer or any instruction execution system. For the purposes of this description, a computer-usable or computer readable medium is any apparatus that can contain, store, communicate, propagate, or transport the program for use by or in connection with the instruction execution system, apparatus, or device, e.g., floppy disks, removable hard drives, computer files comprising source code or object code, flash semiconductor memory (embedded or removable in the form of, e.g., USB flash drive, SDIO module, etc.), ROM, EPROM, or other semiconductor memory devices.

### Example Carrier Ethernet Network

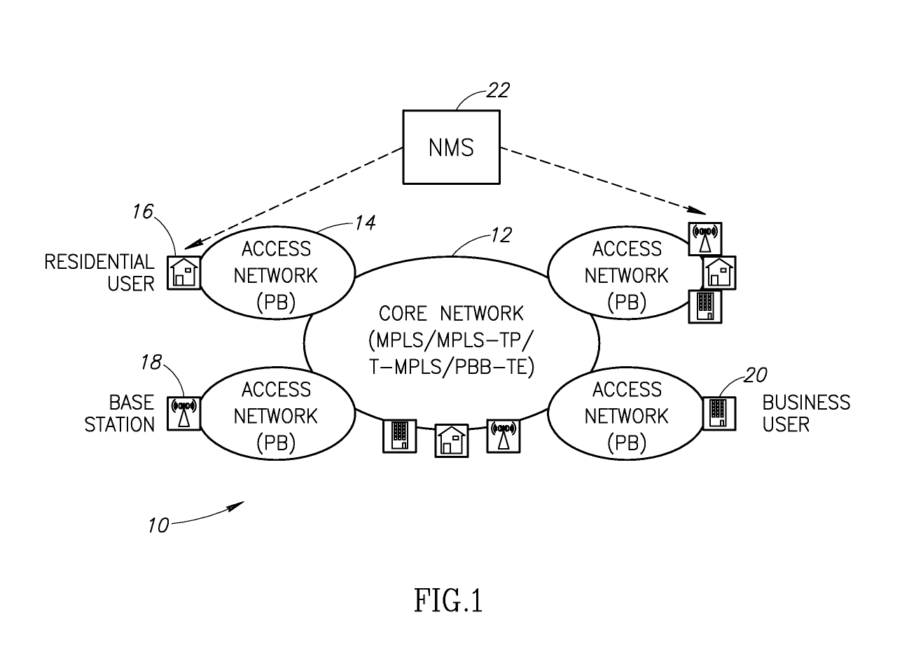

Carrier Ethernet Networks (CENs) or Carrier Ethernet Transport (CET) networks, which are well known for their low price per bits in bandwidth, are increasingly being recognized and widely deployed around the world. A diagram illustrating an example carrier Ethernet network architecture incorporating an MPLS core is shown in FIG. 1. The example Carrier Ethernet Network (CEN), generally referenced 10, comprises a core network 12 and a plurality of access networks 14 connecting users such as residential 16, base stations 18 and business users 20, and a Network Management System (NMS) 22. The core network 12 may use various technologies such as MPLS, MPLS-TP, T-MPLS or PBB-TE. The access network usually comprises Provider Bridging (PB), also known as Q-in-Q but may use various technologies such as MPLS, MPLS-TP, T-MPLS or PBB-TE. Note that throughout this document, the term E-domain is used to refer to PB based access-networks.

The Network Management System (NMS) 22 is operative to manage both the core and access devices from end to end. The management network can be either in-band or out-of-band. In-band management makes use of the service network to transfer the management traffic, while out-of-band management needs a separate Data Communications Network (DCN) dedicated for management purposes. Therefore, in-band management has an advantage over out-of-band management in terms of saving capital expenditures for operators.

The Metro Ethernet Forum (MEF) defines three types of carrier Ethernet services, namely E-Line, Ethernet Local Area Network (E-LAN) and Ethernet Tree (E-Tree), which can be implemented via various underlying technologies, such as VPWS, VPLS, Provider Bridging and PBB-TE, etc.

In provider bridged networks defined by the IEEE 802.1ad standard, each service is identified by a VLAN. For E-LAN/E-Tree service, a Layer 2 control protocol (L2CP), i.e. MSTP or ERP, is used to prevent loops and provide resiliency. In one embodiment, for E-Line service, VLAN-based provisioned traffic-engineered paths are used which require that these VLANs not be effected (i.e. blocked) by the L2CP. In the Carrier Ethernet Transport (CET) network, the service is provisioned with either end-to-end protection or no protection. For end-to-end protected E-Line services, two disjoint paths are provisioned through the network where each path is guaranteed not to have any loops during provisioning, and the L2CP never blocks the paths on any port. PBB-TE is a standard that defines a similar behavior, i.e. provisioned traffic engineered paths that are not affected by the L2CP.

The E-Tree service is the service described by MEF as a ‘rooted multipoint EVC’, similar to an E-LAN service which is described by MEF as a ‘multipoint-to-multipoint EVC’. In operation, E-Tree service provides connectivity between Endpoints defined as ‘leaves’ and Endpoints defined as ‘Roots’ or between Endpoints that are defined as ‘Roots’. E-Tree service, however, denies connectivity between Endpoints defined as ‘Leaves’. Thus, leaves can communicate with roots, roots can communicate with leaves and roots can communicate with other roots, but leaves cannot communicate with other leaves. In other words, ingress service frames at a Root UNI can be delivered to one or more of any of the other UNIs in the service. Ingress service frames at a Leaf UNI can only be delivered to one or more Root UNIs of the service. In addition, a single E-Tree service may have more than one root.

The network may comprise an Ethernet network (i.e. IEEE-802.1Q, IEEE-802.1ad, or IEEE-802.1ah), using ERP or MSTP as the L2CP (hereinafter referred to as an ERP or MSTP network, respectively). The in-band management plane is used to provide the connectivity between the NMS and network elements (NEs). The management protocol comprises any suitable protocol such as SNMP, which belongs to the IP protocol family. For the core network, the management data plane is based on IP forwarding, and the control plane can use any desired routing protocol, i.e. OSPF. For IEEE-802.1 based networks, the management data plane is usually based on a management VLAN; the control plane comprises a L2CP; and the PE(s) of the core network act as static IP gateway(s) for connecting the management plane of the access network with that of the core network. For dual homed access networks, Virtual Router Redundancy Protocol (VRRP) is used to provide IP gateway redundancy.

The IEEE 802.1ag and ITU-T Y.1731 standard define a set of procedures for Connectivity and Fault Management (CFM) of Ethernet entities (e.g., links, VLANs, Ethernet-services, etc.). One of the procedures defined in this standard is called CCM or Continuity Check Messages which enable detecting connectivity failures in the monitored Ethernet entity. Entities which participate in the CCM protocol are called MEG End-Points (MEPs).

Request for Comment (RFC) 4762 “Virtual Private LAN Service (VPLS) Using Label Distribution Protocol (LDP) Signaling” and RFC 4761 “Virtual Private LAN Service (VPLS) Using BGP for Auto-Discovery and Signaling” are IETF standards defining the VPLS service and its implementation. The two standards define two different flavors of VPLS implementation, where the difference is mainly in the signaling protocols and in the auto-discovery (i.e. discovering the peers in the same VPLS).

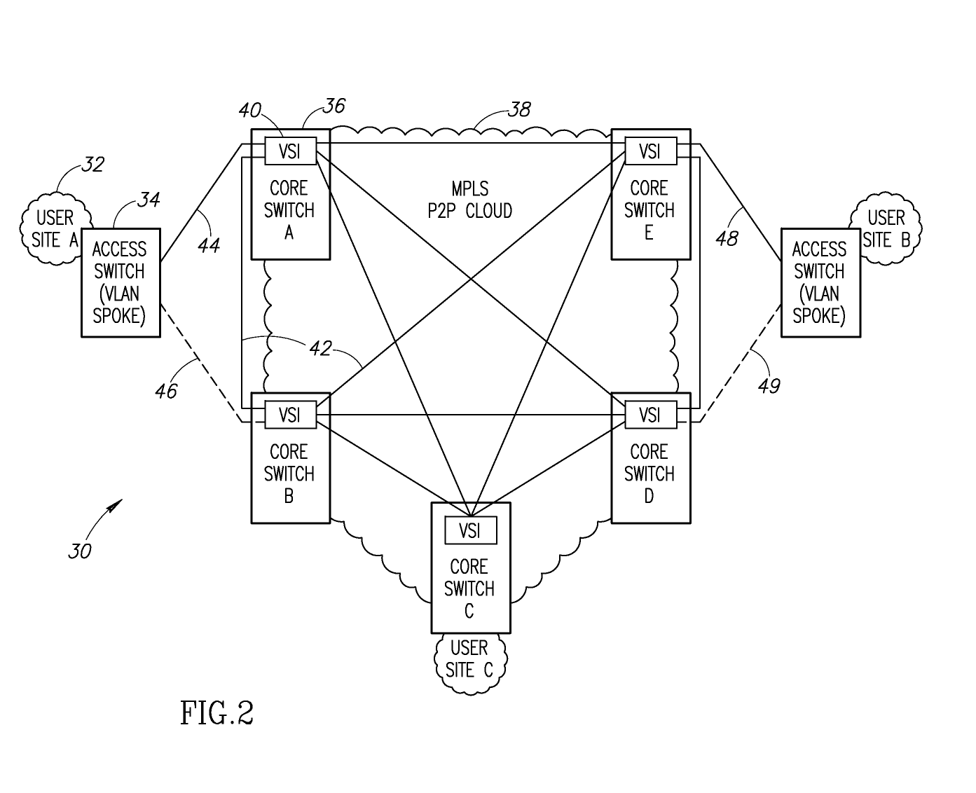

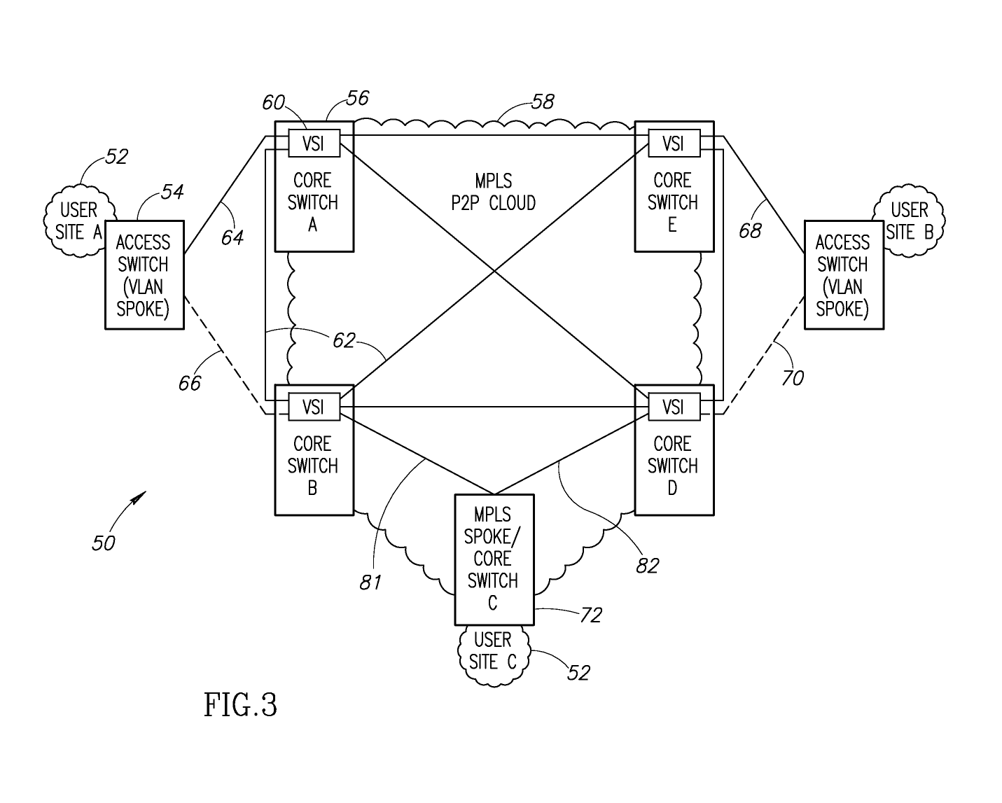

Normally, a VPLS service is built of VSIs placed on one or more MPLS PE devices. With RFC 4762, a full mesh of pseudo-wires (PWs) between the VSIs provides full connectivity between them in order to provide E-LAN functionality. Endpoints of the service either reside on the provider edge (PE) devices or connected to the VSI through the network, for example through a point-to-point spoke. With the spoke-based method, each endpoint is separately connected by a point-to-point path to a VSI of the VPLS. If protection is required, two disjoined point-to-point paths connect the endpoint to the VPLS. An E-LAN service based on VPLS with spokes is illustrated in FIGS. 2 and 3.

A diagram illustrating an example VPLS network with VLAN spokes is shown in FIG. 2. The network, generally referenced 30, comprises user sites 32, dual-homed spoke/access switches 34, core switches 36 which make up MPLS point to point (P2P) cloud 38. User site A is connected to access switch (VLAN spoke) 34 which is connected to VSI 40 in core switch A via link 44 and to the VSI in core switch B via link 46. The VSIs are connected to each other in a full mesh configuration of MPLS pseudo wires. User site B is connected to an access switch connected to the VSI in core switch E via link 48 and to the VSI in core switch D via link 49.

For protection purposes, a dual-homed spoke is connected to two VPLS VSIs using two paths. A path can be: (1) VLAN-spoke based; (2) MPLS pseudo-wire based; (3) a combination of both; or (4) based on other technologies. A VLAN-spoke is a spoke site that resides in a VLAN enabled box (e.g., according to IEEE-802.1Q or IEEE-802.1ad). An MPLS-spoke is a spoke site that resides in an MPLS enabled box. Such a spoke is connected to one or two VPLS VSIs through MPLS pseudo-wires.

A diagram illustrating an example VPLS network with two VLAN-spokes and one MPLS spoke is shown in FIG. 3. The network, generally referenced 50, comprises user sites 52, dual-homes spoke/access switches 54, core switches 56 incorporating VSI 60 which make up MPLS point to point (P2P) cloud 58 and MPLS spoke/core switch C 72. User site A is connected to access switch (VLAN spoke) 54 which is connected to VSI 60 in core switch A via link 64 and to the VSI in core switch B via link 66. The VSIs are connected to each other in a full mesh configuration of MPLS pseudo wires. User site B is connected to an access switch connected to the VSI in core switch E via link 68 and to the VSI in core switch D via link 70. User site C is connected to an MPLS-spoke in core switch C which is connected to the VSI in core switch B through a pseudo wire 81 and to the VSI in core switch D through a pseudo wire 82.

Protection of the spoke connectivity to the VPLS is achieved in the following way. Upon sensing failure of one of the paths, the service endpoint starts using the other path. Detection of the failure can be by an OAM protocol (e.g., the connectivity and fault management (CFM)-continuity check messages (CCM) described supra) or by applying a spanning-tree protocol over the two paths.

Frames forwarded along a network are classified into different traffic classes, where frames of the same traffic class receive the same treatment inside the network (e.g., get the same forwarding priority). Frames belonging to the same traffic class can still have different drop-priority values. Frames of different drop-priority may have different chances to be dropped by the network devices during periods of congestion.

Some networks and equipment support only single traffic-class (TC) services, meaning that all the frames in a service are mapped to the same traffic class. Specifically, many already-deployed networks support only single traffic-class services. In such networks, the TC assigned to each service is a per-service configurable service parameter.

In order to provide multiple classes of service for a customer of a network that only supports single traffic class services, multiple services must be configured: one for each traffic class. User traffic frames should be mapped to the different services according to the traffic class that each frame should get. For example, devices that support single-traffic services only may be capable of classifying and mapping traffic to different services/connections according to VLAN and priority code point (PCP) value (and more fields). Therefore, if the user traffic has multiple PCP values that need to get different quality of service in the network, the device needs to map them to multiple services, each with its own class.

A multi-class service is a service that is able to support one or more classes of service. The TC of the packets is assigned according to TC mapping rules. In most cases this will be according to the PCP (i.e. priority) bits value in the packet customer VLAN-Tag or according to the DSCP field in the IP-header of the packet.

The following is an example of a classification-rules set that can be assigned to a specific service: (1) Packets with C-Tag PCP=5 are assigned to assured forwarding (AF2) TC; (2) Packets with IP DSCP=10 are assigned to AF3 TC. Note that many newer-technology devices and networks support multi-traffic class services.

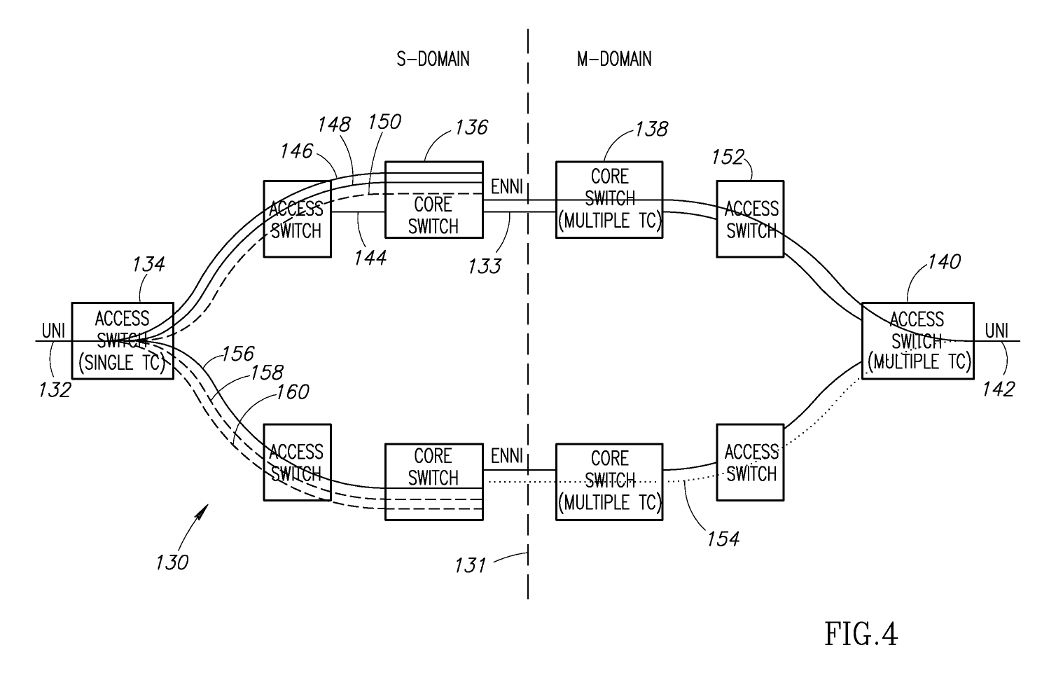

The example network discussed herein comprises domains (i.e. sub-networks) of two types: S-domain which is built of devices that only support single-TC services; and M-domain which is built of devices that support multiple-TC services. The different domains in the network are connected through Ethernet Network to Network (ENNI) links as shown in FIG. 4. The network, generally referenced 130, is divided into S-domain and M-domain sub-networks as indicated by dashed line 131. It comprises UNI 132 connected to access switch 134 that supports single-TC connections, core switches 136, ENNI links 133, multiple TC core switches 138, UNI 142 connected to access switch 140 that supports multi-TC connections. The M-domain comprises a single multiple TC-working path 152 and protection path 154 for UNI 142. The S-domain comprises multiple single TC connections for the working path 146, 148, 156 and protection path 158, 160, 150.

In such a network, a multi-TC service VPLS-based E-LAN service may need to be created with endpoints in both the S-domain and M-domain for which protection must be provided even though part of the network does not support multi-TC services.

One possible solution is to use multiple VPLS services, each of a single traffic class, but all for the same customer-VLAN (or VLANs, entire link, etc.) at the UNI ports. Such a solution, however, may introduce problems when traffic is not continuously sent by a client device over all traffic classes. Specifically, if traffic is sent from a device A only on one TC, the MAC address of device A will be learned only on the VPLS of that TC. All frames that are sent to device A having a different TC will be constantly flooded by the other VPLS services since these services never had a chance to learn the MAC address of device A. This flooding means that the frames are sent to all the endpoints of the service thus creating unwanted congestion in the provider network as well as in the client networks.

An example when this occurs is in the case where Virtual Router Redundancy Protocol (VRRP) is used by two routers which are connected to the multi-TC E-LAN in order to create a single virtual-router that serves as the default gateway to devices connected to it. The downstream traffic from the router is sent using the router MAC and the upstream traffic from the client devices is sent to the VRRP MAC. The VRRP MAC is only sending traffic (e.g., ARP messages) on one traffic class. Therefore, its MAC address will be learned on one VPLS only, and the upstream traffic on the other VPLS services (serving the other traffic classes) will be always be flooded due to being unknown (i.e. sent to a MAC address that was not learned on that VPLS), creating unwanted congestion in the provider network and client networks.

In addition, some of the devices in the M-domain are only able to classify traffic to different services according to VLAN and regard the PCP and DSCP fields of the frames only for deciding the assigned forwarding-class (TC). Since the solution above dedicates a different VPLS service for each TC, the user traffic should arrive to the UNI with multiple VLANs, one for each traffic class. That this is usually not possible makes this another limitation of this solution.

In one embodiment, a different approach to solving the problem discussed supra is to: (1) create a protected VPLS service at the M-domain with endpoints at the ENNI; (2) create a protected service in the S-domain connecting endpoint/s to the ENNI; and (3) protect the ENNI.

One variation of this approach is to provide link-protection only to the ENNI, e.g., using a Link Aggregation Group (LAG) whereby two ENNI links are connected to the same device in each domain (Device S1 in the S-domain connects with two ENNI links to device M1 in the M-domain). This approach, however, does not provide protection from failure of S1 or M1. In other words, the protection scheme is not complete since it has a single point-of-failure.

A second variation is to connect the ENNI links protecting each other to different devices. In this case, more advanced ENNI protection schemes can be used, like multi-chassis LAG, or the IEEE ENNI-protection scheme. In any case, this approach creates a “chicken-and-egg” issue since it requires multi-point multi-TC protected service (at least between each endpoint to the two ENNI devices), which is the feature missing from the S-domain, which is only provided by the mechanism of the present invention. In particular, the mechanism provides the ability to create multi-TC E-line/E-LAN services with endpoints in both the S-domain (the single TC technology domain) and the M-domain (the multi-TC technology domain) and, in addition, provide protection to these services. This is achieved by: (1) mapping a number of single-TC connections to the same interface (e.g., VLAN) at both the UNI and NNI (e.g., ENNI) between the two domains; (2) configuring the bundle of single-TC connections such that the working paths of all single-TC connections in the bundle share the same fate and the protection paths of all single-TC connections in the bundle share the same fate; and (3) coordinating the protection decisions between the single-TC connections in the bundle such that either all of them take the working path or all of them take the protection path.

### Multi-TC Service Protection

In accordance with the invention, in the M-domain, multi-TC service is supported by allowing user traffic of different Traffic-Classes to be transferred on the same service. In the S-domain, however, a service can only have a single TC. To simulate the multi-TC service in the S-domain, the mechanism of the invention bundles multiple single-TC services (i.e. connections) into a multi-TC service. The bundle of the single-TC connections forms a single multi-TC service. The working paths of these single-TC connections are constructed and configured to share the same fate, and all protection paths are engineered to also share the same fate. The working and protection paths are made to share the same fate because the protection decision at the M-domain endpoint is a single one for all Traffic Classes. Therefore, by making sure the working paths of the different single-TC connections in the bundle share the same fate, and that the protection paths of the different single-TC connections in the bundle share the same fate, it is ensured that when a protection decision is made to prefer one of the two paths at the M-domain endpoint; all the single-TC connection-paths that can be reached through that path are operational. The single-TC connections in the bundle are coordinated by forcing the endpoint to make decisions to send traffic over the same path (i.e. all choose the working path or all choose the protection path) in the network for all these connections.

Referring to FIG. 4, the S-domain sub-network is connected to the M-domain sub-network via two ENNI connections. The working paths for the three single TC connections 146, 148, 150 all share the same fate, as do the protections paths 156, 158, 160. OAM Message duplication and filtering is performed at the S-domain border PE side of the ENNI connections.

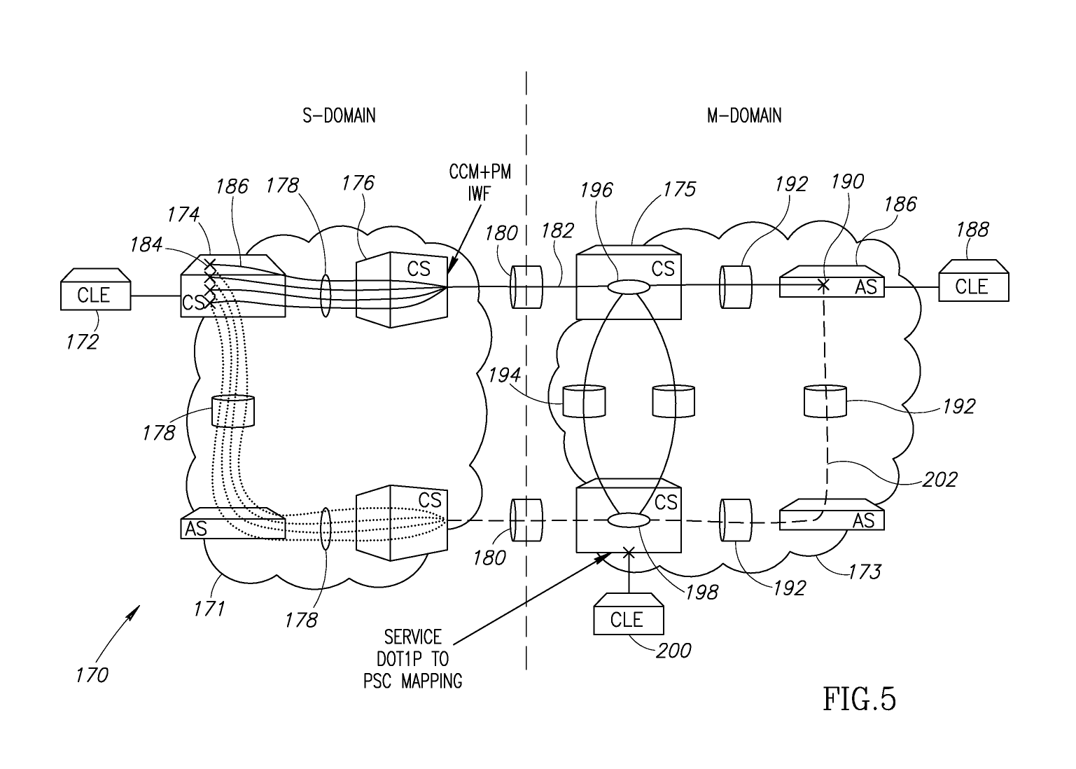

An example E-LAN Service with some endpoints on S-domain single-TC devices and other Endpoints on the M-domain multi-TC devices will now be described. A diagram illustrating a multiple TC E-LAN with endpoints on S-domain and M-domain subnets is shown in FIG. 5. The figure depicts a typical multi-TC E-LAN service, where all endpoints and all VSIs are protected. The network, generally referenced 170, is divided into an S-domain portion 171 and M-domain portion 173. The S-domain portion comprises customer located equipment (CLE) 172, access switches 174, core switches 176 connected to each other via NNI links through which the traffic of the single TC connections flows. The M-domain portion comprises CLE 188, 200, access switches 186 and core switches 175 connected to each other via NNI links through which the traffic of the multi-TC connections flows. Four single-TC connections with endpoints 184 in the S-domain have their working connections 186 mapped to single multi-TC connection 182 in the M-domain (connecting to VSI 196) as well as their protection connections mapped to a multi-TC connection, via ENNI links 180 (connecting to VSI 198). OAM message duplication and filtering is performed on the S-domain side of the ENNI connections in the CCM IWF.

For multi-traffic class E-LAN service, regardless of whether it has UNIs on the M-domain or not: (1) all VSIs 196, 198 for this service are provisioned on devices of the M-domain; (2) the VPLS endpoints on the S-domain 184 are remotely connected to the VSIs 196, 198 in the M-domain; (3) the VPLS endpoints on the S-domain use one connection 186 for each traffic class; (4) the number of connections needed for each VPLS endpoint in the S-domain depends on the number of traffic classes supported by the E-LAN service that this VPLS provides; and (5) all the S-domain connections of a single endpoint are mapped to the same ENNI S-tag (this set of connections is referred to as an “M-bundle”.

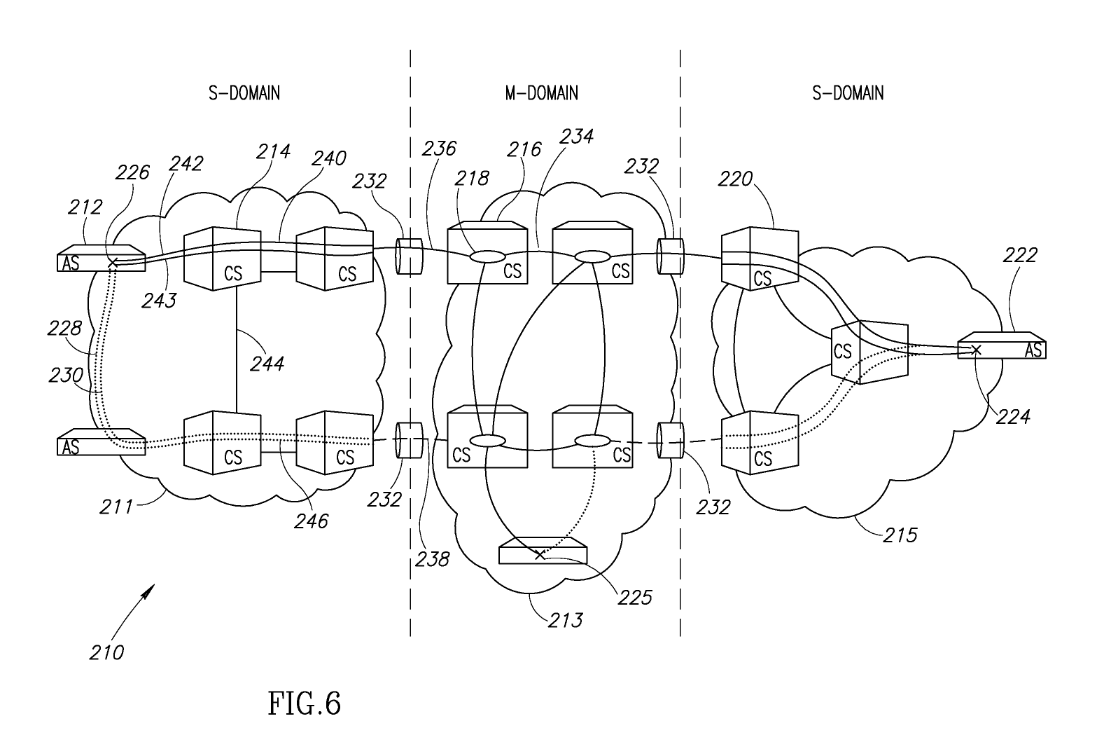

A diagram illustrating multiple VSI based multiple TC E-LAN with endpoints on S-domain and M-domain subnets is shown in FIG. 6. The network, generally referenced 210, is divided into S-domain sub-networks 211, 215 and an M-domain sub-network 213. The S-domain network 211 comprises access switches 212, core switches 214 coupled via MPLS links 244, multiple S-VLAN spokes, one for each TC, at endpoint 226 have their working single TC paths 242, 243 and protection single TC paths 228, 230 connect to the multi-TC connection in the M-domain through the two ENNI links 236, 238, respectively using a single S-VLAN at each ENNI link. These S-VLANs connect to VSIs 218 in the respective M-domain core switches (the ones to which the respective ENNI links connect). MPLS connections 240, 246 are connected between the core switches 214. Single TC MPLS connections with endpoint 226 in access device 212 are mapped to the multi-TC connections in the M-domain sub-network 213 via ENNI links 232.

The S-domain network 215 comprises core switches 220 connected via MPLS links. Single TC MPLS connections with endpoint 224 in access device 222 are mapped to the multi-TC connections in the M-domain sub-network via ENNI links 232.

The M-domain sub-network 213 comprises a plurality of core switches and an access device with endpoint 225. RSVP tunnels 234 connect the core switches to each to each other. Four VSIs 218 communicate with endpoints via multi-TC connections in the M-domain, which, in case of endpoints which are in the S-domain, are connected to single-TC connections in the S-domains.

### One-To-Many OAM-Session Stitching and Decision-Coordinating

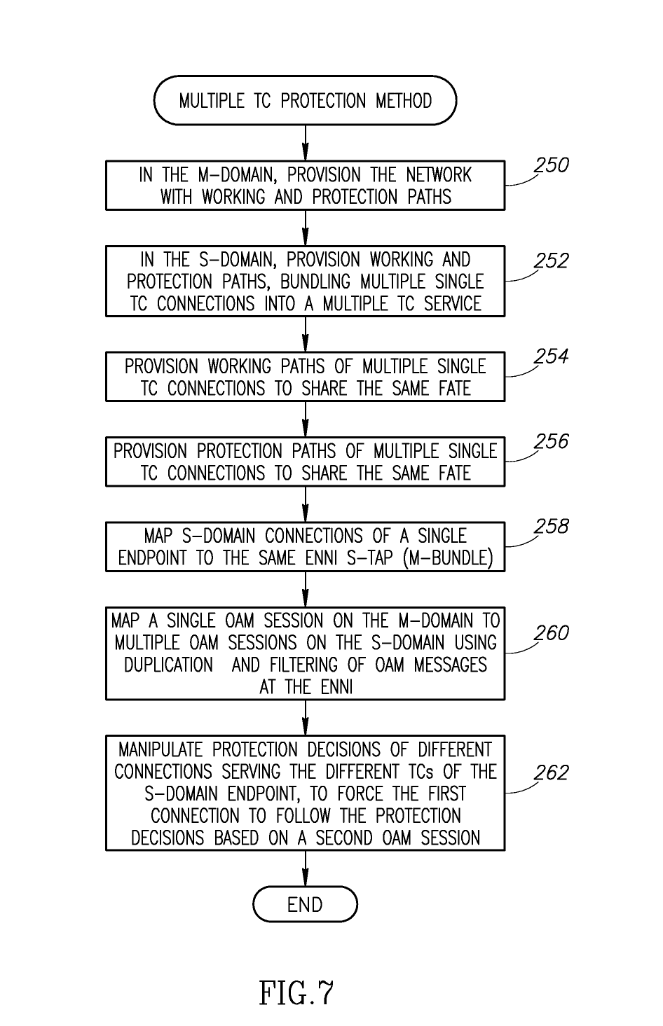

A flow diagram illustrating an example of the one-to-many OAM/protection IWF method of the present invention is shown in FIG. 7. Considering the example networks shown in FIGS. 5 and 6, in particular their topology and connection provisioning , and with reference to FIG. 7, the mechanism of the invention comprises the following two components: (1) stitching a single OAM session (e.g., a CCM session) on the M-domain to multiple OAM-sessions (which monitor different transport entities or connections) on the S-domain using duplication and filtering of OAM messages at the ENNI; and (2) using the OAM sessions and protection decision manipulation in order to coordinate the protection decisions of the different connections serving the different TCs of the same S-domain endpoint. Note that in one embodiment, the protection decision manipulation includes manipulating fields in one OAM-session as a function of information gained from an OAM-session monitoring a different transport entity in such a way that forces the first connection to follow protection decisions that are based on the second OAM-session.

The invention ensures that the connections of the same ‘M-bundle’ are all aligned with the same protection decision at all times. This ensures that frames coming from the same source do not appear in different interfaces of the VPLS at the same time, which is not permitted according to basic layer-2 bridging rules and therefore causes loss of service. This is not permitted according to basic IEEE-802.1 and VPLS bridging rules as explained as follows. Two H-VPLS implementations are possible, either to block or not block the traffic at the inactive VSI-interface. In both cases, having different single-TC connections sending traffic to both VPLS interfaces results in faulty behavior of the network. If one VSI-interface blocks traffic due to being the currently inactive interface, the single-TC connections that send traffic to it will be disconnected from the service. If the currently inactive VSI-interface is not blocked, frames with the same source MAC-addresses will be received at different interfaces of the same VPLS. The reason is that when the same client device sends traffic in different TCs, the traffic is directed to different single-TC connections, which sends it to different VPLS interfaces (due to not being coordinated). When the same MAC address appears in different interfaces, the VPLS-engines keep on relearning these MAC-addresses in the different interfaces, causing traffic to be forwarded randomly to each interfaces, and therefore not being received (if the specific single-TC connection to which the frame is transmitted uses the other path). In addition, the VPLS-engines may suffer from performance issues or even fail due to the intensive learning cycles.

An OAM Inter-Working Function (IWF) at the S-domain ENNI border PE is configured to support the following functionality. (Note that the IWF may alternatively also be implemented at the M-domain border PE) First, CCM messages over connections belonging to the M-bundle of the service in the S-domain to M-domain direction that are associated with the service are filtered and only the CCM messages with the highest priority are forwarded via the ENNI. In other words, connections can be either ‘leaders’ or ‘followers’. The leader connection is selected as the connection with the highest priority. All other connections are considered followers. Second, the CCM messages that are sent from the M-domain VSI towards a bundle of S-domain connections that is associated with the service via the ENNI, are replicated into several CCM messages, one for each of the single-TC S-domain connections from which the M-bundle of the respective multi-TC service is built.

The technique of coordinating protection decisions using the stitched OAM sessions will now be described in more detail. The protection decision at the endpoints is performed according to the CCM indications. Specifically, the endpoints choose an operational path, i.e. one from which CCM messages with RDI=0 are received. This fact is used for coordinating all the lower TC S-domain connections with the protection decision made according to the highest TC S-domain CCM sessions.

This requires the CCM messages to include an indication of the actual chosen path. More specifically, each CCM message comprises an indication saying whether it is being forwarded over the path that is currently being used for forwarding data (i.e. active) or over the path that is currently on standby (i.e. inactive). In one embodiment, this indication is added to the CCM messages by adding a vendor-specific TLV containing this information. The information is coded using (1) a single active/inactive flag; (2) two fields: one indicating whether the CCM is sent over the working or the protection path and a second indicating which path is currently active; (3) any other suitable message coding technique.

It is appreciated that the OAM manipulation logic of the invention can be implemented in different points in the network, for example: (1) at the devices which hold the VPLS VSIs; (2) at the devices which hold the endpoints; (3) at the S-domain side of the ENNI links at the border PE; (4) at the M-domain side of the ENNI links at the border PE; or (5) at any other devices in the middle of the S-domain or M-domain.

Options (3) and (4) described supra are preferred since they limit to a minimum the number of devices that need to be upgraded with the mechanism of the invention. This is also an advantage of the invention in that it can be implemented by applying modifications in relatively few network devices, i.e. only those devices directly connected to the ENNI links. More particularly, only one of the network devices connected to each ENNI link needs to be adapted to implement the mechanism of the present invention. This also implies that only one type of network device be modified (i.e. either those belonging to the single TC network or those belonging to the multi TC network).

It is also appreciated that the OAM manipulation logic of the invention can be implemented in the data-plane or in a CPU. Implementation in the data plane is likely preferred because of the following: (1) forwarding OAM traffic for processing in a CPU involves considerable delays and bottle necks which will likely reduce the OAM and protection accuracy, reliability, and scalability; and (2) since user data is not processed in the device's CPU, OAM messages that is processed at the CPU is less representative of the data it measures.

An advantage of the mechanism is that it requires relatively simple processing of the message frames and a very low amount of state (e.g., one bit per session), thus being suitable for implementation in the data plane. The implementation of the mechanism in CET is in the network processor at the ENNI port of the S-domain border device.

In an alternative embodiment, additional processing on the OAM messages is performed in addition to the processing required by the mechanism of the invention, for example: (1) changing source MAC address and IEEE802.1ag MA/ME names so that separate standard OAM sessions are created between the point in which the invention is implemented and the endpoints/VSIs' and (2) conversion of OAM message format. The decision to perform additional processing on the OAM messages typically depends on the specific technologies used in the S-domain and M-domain.

It is further appreciated that the information about the currently active path may take different routes to arrive at the entity in which the logic of the invention is implemented. In a preferred embodiment, this information is carried in the OAM messages monitoring the working and protection paths. In a second embodiment, when this information is only carried in G.8031 APS messages, the information can be extracted from the G.8031 messages traveling over the protection path. In this case, a coordination protocol is used in order to ensure that the two devices implementing the IWF (one through which the working path flows and another one through which the protection path flows) have this information, although the G.8031 messages travel through only the protection path.

It is noted that the mechanism of the invention allows connecting networks of different technologies (networks only supporting single-TC connections and networks only supporting multi-TC connections) and provides a coherent multi-TC E-LAN service. It allows an operator to provide multi-TC E-LAN services over networks which only provide single-TC services by adding several multi-TC-supporting network devices to it which can implement the VSIs.

Referring to FIGS. 5, 6, and 7, the network is provisioned in the M-domain (multi-TC) with working and protection paths (step 250). Similarly, in the S-domain (single-TC) working and protection paths are provisioned and multiple single-TC connections are bundled into one or more multiple-TC services (i.e. M-bundles) (step 252). The working paths of the multiple single-TC connections in the S-domain are provisioned/configured to share the same fate (step 254). Similarly, the protection paths of the multiple single-TC connections in the S-domain are provisioned/configured to share the same fate (step 256). Thus, a failure in any of the links making up one of the (working/protection) paths of a single-TC connection, affects the same path in all the other single-TC connections. The S-domain connections of a single endpoint are mapped to the same ENNI S-tap (M-bundle) (step 258).

A single OAM session in the M-domain is then mapped to multiple OAM sessions in the S-domain using duplication and filtering of OAM messages at the ENNI (step 260). Protection decisions of different connections servicing the different TCs of the S-domain endpoint are manipulated to force the first connection (‘follower’ connections of the M-bundle) to follow the protection decisions based on a second OAM session (which monitors the ‘leader’ connection of the same M-bundle) (step 262).

In one embodiment, in the direction from the S-domain endpoint to the VSI at the M-domain, the ENNI IWF at the S-domain border device, for a multi-TC service, receives from the S-domain endpoint a CCM message for each of the service TCs (priorities). The ENNI IWF at the S-domain border device, for a multi-TC service, only forwards CCMs associated with the highest priority connection toward the ENNI port. All other CCMs are dropped.

In the direction from the VSI at the M-domain to the S-domain endpoint, the ENNI IWF at the S-domain border device, for a multi-TC service, receives from the VSI a CCM message for the highest priority connection. The ENNI IWF at the S-domain border device, for a multi-TC service, duplicates a received CCM to all TCs (i.e. connections).

Note that for each multi-TC service configured on ENNI, the IWF maintains a path state parameter. The path state is used for the M-domain to S-domain direction CCM interworking and has two values: (1) “active”: the service endpoint uses this path to transmit user traffic; or (2) “inactive”: the service endpoint does not use this path to transmit user traffic. A path state transition diagram is presented in Table 1 below where the ‘inactive’ and ‘active’ states indicate next path state.

TABLE 1
Path state transitions

| | Events | | |
|---|---|---|---|
| | No CCM received | Highest | Highest |
| | from S-domain | TC S-domain | TC S-domain |
| | endpoint since | CCM indicates path | CCM indicates path |
| Path state | IWF initiation | used | not used |
| Inactive | Inactive | Active | Inactive |
| Active | NA | Active | Inactive |

For the M-bundle cross-connect for each valid received CCM frame received from the M-domain, the data plane generates a CCM frame for each connection configured for this M-bundle. The RDI-flag value in CCM frames is used to coordinate the protection decision of the lower-TC S-domain connections to the decisions made by the highest-priority connection. In order to achieve this, the IWF sets the value of the RDI field in CCM messages that it forwards according to the state of the path through which they flow, as maintained by the IWF.

If the path state is “active”, then the originated CCM frame is forwarded with an unchanged RDI-flag value. If the path state is “inactive”, then if the originated CCM frame contains RDI flag=0: the RDI of the CCM frame generated for the highest priority connection in the M-bundle is set to ‘0’ and the RDI flag of the CCM frames generated for the lower priority connection in the M-bundle is set to ‘1’. If the originated CCM frame contains RDI flag=1, then the RDI flag of all CCM frames is set to ‘1’.

### Switch Embodiment Incorporating One-to-Many OAM/Protection IWF Mechanism

A switch device can be adapted to incorporate the one-to-many OAM/protection IWF mechanism. Hardware means and/or software means adapted to execute the mechanism may be incorporated within a network device, typically a core switch. It is appreciated that the mechanism may be implemented in a core switch, provider edge switch, Network Management System, Label Switching Router (LSR), Ethernet LAN switch, network switch or any other wired or wireless network device. The device may be constructed using any combination of hardware and/or software.

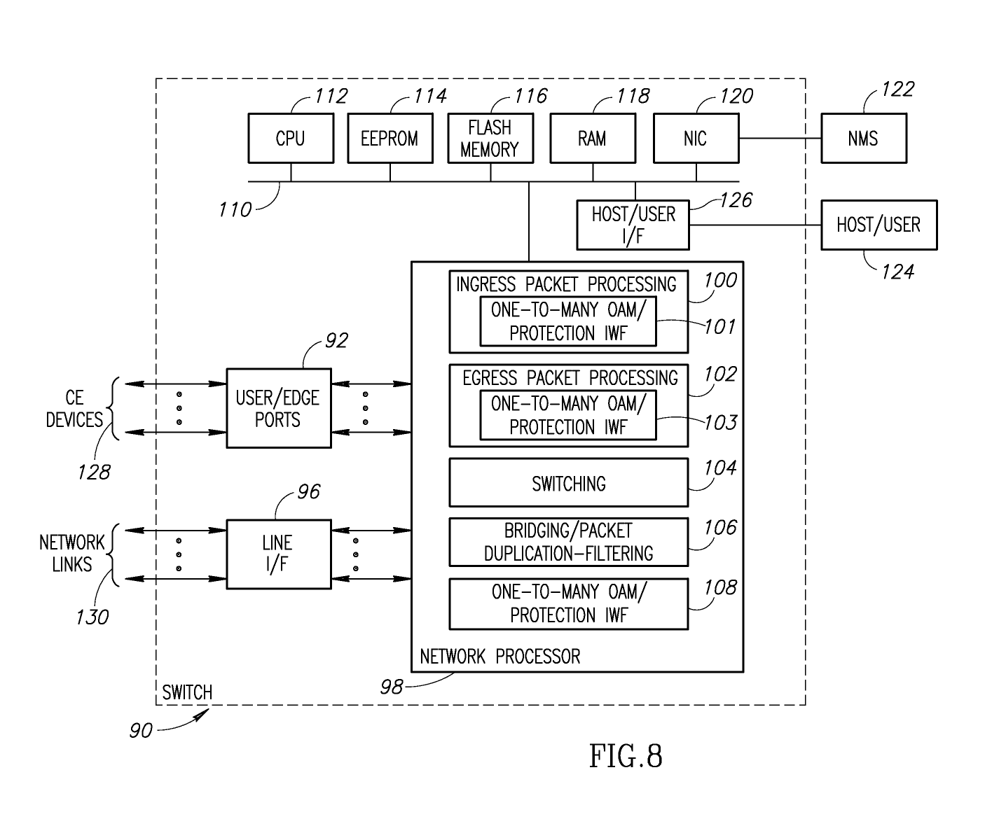

A block diagram of an example switch incorporating the one-to-many OAM/protection IWF mechanism of the present invention is shown in FIG. 8. The switch, generally referenced 90, comprises at its core a network processor 98, link or network interface ports 96, edge or user ports 92, a network interface 120 for interfacing the switch to an NMS 122, a central processor 112, e.g., CPU, and both volatile and non-volatile memory including RAM memory 118 for storing data and application program code, Flash memory 116 for storing boot and application code and EEPROM 114 for storing configuration data. The CPU communicates to the network processor, memory peripherals and other support devices via a bus 110.

The switch 90 comprises a user side and a network side. The one or more line interface cards containing network ports 96 provide the PHY interface to two-way communication links 130. As an example, the line interface cards may be adapted to interface to any combination of the following communication links: any variety of copper or optical based Ethernet, Token Ring, FDDI, SONET/SDH, ATM, RPR, etc.

A plurality of edge ports 92 is provided for connecting directly or indirectly to any number of CE devices via links 128. The edge ports interface to the CE device via any suitable type of interface, e.g., Gigabit Ethernet (GE), Fast Ethernet (FE), 10GE, SONET/SDH, PDH interface (e.g., TI/EI), etc. Likewise, the network side interfaces to MPLS domain devices and/or other devices via any suitable interface such as Optical Ethernet (e.g., 1GE, 10GE, etc.), TDM SONET/SDH/PDH, RPR, etc.

A plurality of switches may be connected to each other to form a carrier network, ERP ring network, MSTP ring network, etc. whereby one or more of the switches are connected to MPLS core switches. In this case, connections may be built using both VPLS and MPLS based technology. Alternatively, the network may comprise a single MPLS switch and a plurality of E-domain devices connecting any number of CE devices, such as in a ring topology.

The network processor 98 implements the switching fabric (switching block 104) for providing the switching functionality of the device and bridging/packet duplication functions (block 106). Depending on the specific implementation, the switching fabric may comprise, for example, hardware for performing VLAN tagging, MPLS, Frame Relay, ATM switching, CSIX or any other fabric to network interface protocol. The network processor includes one or more packet processing engines (PPE) that comprises an ingress packet processor 100 and an egress packet processor 102. The network processor also comprises timestamp circuits, clock circuits, memory, counters and CPU interface (not shown), means for performing OAM protocol (e.g., ITU Y.1731, IEEE 802.1ag, etc.) processing (part of this capability may reside in the CPU as well). The network processor may be implemented as a microcontroller, microprocessor, microcomputer, ASIC core, FPGA core, central processing unit (CPU) or digital signal processor (DSP) or any other suitable computing means.

The switch also comprises a NIC 120 for providing an out of band interface for connecting to external entities such as a craft for local maintenance and configuration purposes, an NMS for centralized provisioning, administration and control or a Local Area Network (LAN). The switch may comprise additional interfaces, such as a serial interface for connecting to a PC for configuration purposes and an interface to an NMS for in-band management.

The central processor 112 implements the major functionality of the switch including higher software layer processing, and in one embodiment implements the OAM and protection IWF mechanism of the invention. Note that the central processor may be implemented in any suitable manner such as a microcontroller, microprocessor, microcomputer, ASIC core, FPGA core, one or more central processing unit (CPU) cores or digital signal processor (DSP) cores or any other computing means.

The client edge ports and network ports may be implemented on one or more line interface cards that provide the PHY interface to bidirectional communication links, in addition to the MAC interface. Note that the invention is not limited to any particular line interface type or link speed. In addition, the invention is not limited to any particular number of user or network ports, as any number of links of each type may be used. Further, the line interface cards may be adapted to interface to any type of communication links such as any variety of copper or optical based Ethernet, Token Ring, FDDI, SONET/SDH, PDH, ATM, RPR, etc.

The switch also comprises an optional user interface adapted to respond to user inputs and provide feedback and other status information. A host/user interface 126 enables communication with a user or host-computing device 124. The host may be adapted to configure, control and maintain the operation of the device. The switch may also comprise magnetic storage device means for storing application programs and data.

The switch comprises computer readable storage medium for storing program code and data which may include any suitable memory means including but not limited to magnetic storage, optical storage, CD-ROM drive, ZIP drive, DVD drive, DAT cassette, semiconductor based volatile or non-volatile memory, biological memory devices, or any other memory storage device.

Note that a network core device may have the same structure as a provider edge device, except for example, not having a user/edge (UNI) port for connecting to client and/or access devices, and having a higher port density and bandwidth capacity.

Software operative to implement the functionality of the one-to-many OAM/protection IWF mechanism may be adapted to reside on a computer readable medium, such as a magnetic disk within a disk drive unit or any other volatile or nonvolatile memory. In this example switch, the software adapted to implement the portion of the one-to-many OAM/protection IWF mechanism that executes on the network processor is implemented within the ingress packet processing block 100 (depicted in block 101) and within the egress packet processing block 102 (depicted in block 103) or as a separate module 108. For example, a table, maintained by the CPU, can be used in performing ingress and egress processing. The table comprises VPLS, MPLS and VSI related MAC address and other information including VLAN address translation and path state information. Alternatively, the computer readable medium may comprise a floppy disk, Flash memory, EPROM, EEPROM based memory, ROM storage, etc. The software adapted to perform mechanisms or any portion thereof may also reside, in whole or in part, in the static or dynamic main memories or in firmware within the processor of the switch (i.e. within microcontroller, microprocessor, microcomputer, DSP, etc. internal memory).

In alternative embodiments, the methods of the present invention may be applicable to implementations of the invention in integrated circuits (ICs), field programmable gate arrays (FPGAs), chip sets or application specific integrated circuits (ASICs), DSP circuits, wireless implementations and other communication system products.

The terminology used herein is for the purpose of describing particular embodiments only and is not intended to be limiting of the mechanism. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the mechanism has been presented for purposes of illustration and description, but is not intended to be exhaustive or limited to the mechanism in the form disclosed. As numerous modifications and changes will readily occur to those skilled in the art, it is intended that the mechanism not be limited to the limited number of embodiments described herein. Accordingly, it will be appreciated that all suitable variations, modifications and equivalents may be resorted to, falling within the spirit and scope of the mechanism. The embodiments were chosen and described in order to best explain the principles of the mechanism and the practical application, and to enable others of ordinary skill in the art to understand the mechanism for various embodiments with various modifications as are suited to the particular use contemplated.

What is claimed is:

1. A method of providing end to end OAM connectivity in a carrier Ethernet network (CEN), said method comprising:
provisioning a first group of connections;
provisioning an additional single connection; and
mapping a plurality of administration and maintenance (OAM) sessions on said first group of connections to a single OAM session on said single connection.

2. The method according to claim 1, wherein said first group of connections comprise single traffic-class (TC) connections serving different TCs of the same endpoint.

3. The method according to claim 1, wherein said single connection comprises a multiple TC connection.

4. The method according to claim 1, wherein said first group of connections is provisioned in one domain of said CEN (S-domain) and said single connection is provisioned in a second domain (M-domain) of said CEN.

5. The method according to claim 1, further comprising manipulating protection decisions for said first group of connections.

6. The method according to claim 1, wherein said mapping is performed by duplication and filtering of OAM messages.

7. The method according to claim 1, wherein said mapping is performed by duplication and filtering of OAM messages at an Ethernet Network to Network Interface (ENNI).

8. The method according to claim 1, wherein said mapping is performed such that said first group of connections, which are mapped to said single connection, share the same fate.

9. The method according to claim 1, wherein each of the connections in said first group of connections and said single connection, comprise a pair of disjoined transport-entities (paths) operative to protect each other, wherein each transport-entity is monitored by a separate OAM session.

10. The method according to claim 9, wherein a transport-entity comprises a succession of one or more VLAN-based paths or MPLS PW based paths.

11. The method according to claim 9, wherein said mapping is performed such that the transport entities (paths) of said first group of connections mapped to said single connection is divided into two groups of paths comprising a working fate-group and a protection fate-group, wherein the paths in the working fate-group share the same fate, and the paths in the protection fate-group share the same fate.

12. The method according to claim 11, wherein manipulating protection decision comprises coordinating all connections in said first group of connections such that their active paths all belong to the working fate-group or all belong to the protection fate-group.

13. The method according to 12, wherein said coordinating comprises choosing one connection from said first group of connections and forcing all other connections in said group of connections to choose their active path based on the decisions made by said one chosen connection.

14. The method according to claim 5, wherein manipulating protection decisions comprises setting one or more fields in a first OAM session monitoring a first transport entity as a function of information learned from a second OAM session monitoring a second transport entity such that said first transport entity is forced to follow protection decisions based on said second OAM session.

15. The method according to claim 5, wherein manipulating protection decisions comprises setting one or more fields in a first OAM session monitoring a first transport entity as a function of information learned from a G.8031 APS protocol session operating on the connection containing the second transport entity such that said first transport entity is forced to follow protection decisions based on said APS protocol.

16. The method according to claim 5, wherein said manipulating protection decisions comprises setting an indication of a failure in the messages of the OAM session monitoring the paths that should be chosen as inactive.

17. The method according to claim 16, wherein said setting an indication of a failure in the OAM messages comprises setting a Remote Defect Indication (RDI) flag in CCM messages.

18. The method according to claim 5, wherein said manipulating comprises inserting an indication in OAM continuity check messages (CCMs) as to whether the message is being forwarded over either an active path or a standby path.

19. The method according to claim 5, wherein said manipulating comprises inserting a first flag in an OAM continuity check message (CCM) indicating whether the CCM is being sent over a working or protection path, and a second flag indicating which of the working or protection paths is currently active.

20. A method of providing end to end protection in a carrier Ethernet network (CEN), said method comprising:
provisioning a first group of connections in an S-domain of said CEN;
provisioning an additional connection in an M-domain of said CEN;
mapping a plurality of operation, administration and maintenance (OAM) sessions on said group of connections to a single OAM session on said single connection; and
manipulating protection decisions for said first group of connections such that active transport entities of said first group of connections mapped to said single connection all share the same fate.

21. The method according to claim 20, wherein said first group of connections comprise single traffic-class (TC) connections serving different TCs of the same endpoint and said single connection comprises a multiple TC connection.

22. The method according to claim 20, wherein said mapping is performed by duplication and filtering of OAM messages.

23. The method according to claim 20, wherein said manipulating comprises choosing one connection from said first group of connections and forcing all other connections in said group of connections to choose their active path based on the decisions made by said one chosen connection.

24. The method according to claim 20, wherein manipulating comprises setting one or more fields in a first OAM session monitoring a first transport entity as a function of information learned from a second OAM session monitoring a second transport entity such that said first transport entity is forced to follow protection decisions based on said second OAM session.

25. The method according to claim 20, wherein OAM messages from said group of connections in said S-domain destined to said single connection in the M-domain are filtered whereby only the messages with the highest priority are forwarded.

26. The method according to claim 20, wherein OAM messages from said single connection in said M-domain destined to said group of connections in the S-domain are replicated into a plurality of messages, one for each connection from which said group of connections is constructed.

27. The method according to claim 20, wherein said mapping is performed by duplication and filtering of OAM messages at the S-domain side of an Ethernet Network to Network Interface (ENNI).

28. The method according to claim 20, wherein said mapping is performed by duplication and filtering of OAM messages at the M-domain side of an Ethernet Network to Network Interface (ENNI).

29. The method according to claim 20, wherein said manipulating comprises setting an indication of a failure in the OAM messages comprises setting a Remote Defect Indication (RDI) flag in CCM messages.

30. The method according to claim 20, wherein said manipulating comprises inserting an indication in a CCM message as to whether the message is being forwarded over either an active path or a standby path.

31. The method according to claim 30, wherein said indication comprises a type, length value (TLV) inserted in said CCM message.

32. The method according to claim 20, wherein said manipulating comprises inserting a first flag in a CCM message indicating whether it is being sent over a working or protection path, and a second flag indicating which of the working or protection paths is currently active.

33. A communications switch for use in a carrier Ethernet network, comprising:
a plurality of network ports for interfacing said switch to one or more communication links;
a network processor comprising a multiple traffic class (TC) protection module operative to provide end to end protection in said carrier Ethernet network;
said multiple TC protection module operative to:
mapping a plurality of operation, administration and maintenance (OAM) sessions on a first group of connections to a single OAM sessions on a single connection;
manipulating protection decisions for said first group of connections such that all active paths in said first group of connections share the same fate.

34. The communications switch according to claim 33, wherein manipulating comprises choosing one connection from said first group of connections and forcing all other connections in said group of connections to choose their active path based on the decisions made by said one chosen connection.

35. The communications switch according to claim 33, wherein manipulating comprises setting one or more fields in a first OAM session monitoring a first transport entity as a function of information learned from a second OAM session monitoring a second transport entity such that said first transport entity is forced to follow protection decisions based on said second OAM session.

36. The communications switch according to claim 33, wherein said manipulating comprises setting an indication in an OAM continuity check message (CCM) as to whether the message is being forwarded over either an active path or a standby path.

37. The communications switch according to claim 33, wherein said manipulating comprises inserting a first flag in an OAM continuity check message (CCM) indicating whether it is being sent over a working or protection path, and a second flag indicating which of the working or protection paths is currently active.

38. The communications switch according to claim 33, wherein said manipulating comprises setting a Remote Defect Indication (RDI) flag in an OAM continuity check message (CCM) sent over one transport-entity (path) of a connection in order to force the connection to choose the other transport-entity (path) as the active-path.
